(19) United States
(12) Patent Application Publication
(10) Pub. No.: US 2007/0198635 A1
(43) Pub. Date: Aug. 23, 2007

(54) Apparatus and method for interpretation and enrichment of documents and exchange thereof

(75) Inventors: Wolfgang Lindner, Eisfeld (DE); Clemens H. Cap, Rostock (DE)

Correspondence Address: AWAMBA INC., 31 Hillside Ave, Stoneham, MA, 02180, US

(73) Assignee: Awamba Inc., Cambridge, MA (US)

(21) Appl. No.: 11/608,041

(22) Filed: Dec. 7, 2006

Related U.S. Application Data
(60) Provisional application No. 60/597,578, filed on Dec. 12, 2005.

(51) Int. Cl. G06F 15/16

(52) U.S. Cl. 709/203

(57) ABSTRACT

The present invention allows computer users to enrich network loaded documents, including HTML-sites, discussion boards, forums, blogs, chat sessions, web links, and documents represented in a browser, with additional information from a multitude of information sources which can be web-based or locally stored. The enrichment of information is controlled by a cooperative system component, which includes an interceptor to obtain location information, an analysis component to extract data from the web-based information, application cases stored in an application case store to categorize the available information and their use, a client side application logic which manages the information processing and formats the output of additional information, which is represented in an additional output component in form of text, graphic, audio, video, animation, executable content and other document types. The cooperative system component can also influence the output component of the user's browser in the manner that the user requested web-information can be shortened, replaced, modified or hidden. The invention further allows to process and analyze the enriching information provided by a specific user, a closed group of users or all users within the network, thereby allowing to provide a statistical report on the information provided by the user.

### CROSS-REFERENCE TO RELATED APPLICATIONS

This application claims the benefits of U.S. Provisional Application No. 60/597,578, filed Dec. 12, 2005, entitled “Apparatus and method for interpretation and enrichment of documents and exchange thereof.” The entirety of this application is incorporated herein by reference.

### SUMMARY OF INVENTION

An apparatus for organizing, analyzing, processing, generating, interpreting, intercepting, presenting, registering, enriching, and exchanging information or a collection of documents, comprising: (A) a client having a browser and a cooperative system component; a network; a server for original documents; a server for additional information; and optional: a control model and/or template server; (B) the cooperative system component, comprising: an interceptor, an analysis component, a control model store, a client-side control logic, and an additional output component; (C) the client-side control logic, comprising: a communication component, a data cache, a template cache, and a template engine; (D) the server for additional information, comprising a server-side control logic.

A method for generating output content with utilization of user input comprising the methods of: a method for description of control models; a method for interception of document request or document arrival; an optional method for analysis of user requested documents; and (A) an optional method for modification of requested documents in form and/or content, and a method for presenting the user requested document in a main output component; or (B) a method for loading and generation of additional documents, and a method for presenting additional documents in an additional output component; in which the subscription of control models defines the exact manner of executing these methods.

The present Invention relates in general to documents and their user specific interpretation and enrichment with additional information in reference to specific control modules. Examples for additional information are, but not limited to: web pages, biographies, polls, adult protection marks, translations in different languages, forums, chats, blogs, forms, VoIP, audio, video, product information, user feedback, reviews, explanations, definitions, hints for paper chase games, a digital signature on documents serving as proof for exchanged document content or business transaction by electronic means, information which can be used to quantify or rank remarks or users, advertisement as well as any links thereof.

In the generic form of the embodiment, a user views a document, loaded by a computer network such as the Internet. The user is subsequently enabled to provide own information regarding the viewed document, in the simplest form by adding feedback and in more complex embodiments by adding information in a form which helps to solve a considerable number of presently unsolved document or web-document communication problems. Said embodiment enables the user to provide information enriching viewed document, such that the information supplied by the user is not sent, administrated (and possibly modified or even censored) by the author of the web page to which said information is provided, but in contrary can be viewed by all other users of the Internet who have configured their browser in a manner that they are connected with the services provided by our invention, and/or the process that the users can provide public accessible or restricted information enriching the web site cannot be influenced or interfered with by third parties, and/or the information provided by other users is closely connected with the document to which this information is provided in such a way that a user who downloads the document has immediate access to the information provided by all other users.

In a specific embodiment, the network loading engine loads a user requested document into the document representation interface to provide the analysis component with document information. The analysis component analyses the document to select specific identification information for example International Standard Serial Numbers (ISSN) for identification of newspapers, magazines or the like, International Standard Book Numbers (ISBN) for identification of books and non proceeding publications, Document Object Identifier (DOI) for explicit and perpetual identification of digital objects or Label Codes (LC) or International Standard Recording Codes (ISRC) for identification of music content and their assignment to exploitation rights or universal product codes (UPC) or European article numbering (EAN) codes for the identification of consumer products. Identification information can be standardized information with a mathematical basis of computation like ISBNs and checksum rules, globally allocated numbers like LCs, unique identifiers, or other allocated identification characteristics. In dependency of the characteristics of the demanded information the analysis component uses calculation methods and/or comparison methods to obtain the identification information. In this special embodiment the client-side control logic uses this identification information to look for offers, such as from commercial online book stores, and presents hits in the additional output component. The presentation form can include a link to the commercial offerer, a method for a direct purchase, or mixed content, or other content like further product information. In a variant of this specific embodiment, the client-side control logic sends the product identification information to a server where the additional information is stored or derived.

In another specific embodiment, the user requests a document at an electronic commerce shopping or auctioning site. The analysis component extracts product identification information either using methods of the previous embodiment or by searching the document at those places where said electronic commerce shopping site usually displays product identification information. The information about these places may be stored as part of the description of the control module. Then the client-side control logic derives links under which additional information on said products is stored or obtains such information from a server.

In another specific embodiment, the user requests a document located in a network, for example a HTML-site on the internet. The user requested document contains objects like products, persons, or countries. The analysis component analyses the document and identifies the objects. The user can add information to one or all of these objects, for example in the form of text notes. These remarks are now bound to its objects. The client-side control logic connects the server for additional information and in dependency of the located objects, remarks of other users connected to the network will be received and can be presented in the additional output component after the modification and generation process in the client-side control logic. In addition the user remarks to one or more objects can now be received from the users in the network for viewing. A remarked object can also be a document location, e.g. URL, or the whole content of a web document at the specified location. If a user provides a remark to a document then the technology of the disclosed invention ensures that said remark will also be displayed as a remark of a document which is stored under a different document location but has identical or similar contents than the document which originally was remarked.

In another specific embodiment, remarks made by a user are not linked to the web page itself (or rather its URL), but to the topic the web page or another networked based document or service is about. For this purpose the analysis of the user requested document performs an extensive analysis of the content of the document or web-provided service (especially, but not restricted to document fingerprints or full text analysis). As a result the client-side control logic forwards the pertinent information to the server for additional information. This information can consist of meta information provided in the document itself (such as Dublin Core information, RDF information, XML-based information, HTML meta tags or other forms of document meta information), characteristic keywords spotted in the document, abstract information provided by the document itself, abstract information provided by an automated abstract generator, or Rabin document fingerprints. This information serves to identify the topic of discourse of the analyzed document. The remarks then are stored in the server for additional information together with this information. In another variant of this embodiment, the server for additional information can do a further processing of this information and join similar topics. In another variant of this embodiment, the information sent by the analysis component to the server for additional information does not serve to identify the specific topic but only helps the server for additional information to find similar topics (i.e. for storing a remark with a topic, it is not necessary to explicitly identify a single topic, it also suffices to find a number of similar topics and store the remark with the found cluster of similar topics).

In another specific embodiment, the client-side control logic provides standardized masks, drag-and-drop elements, and standardized interaction options for user support to prevent incorrect inputs and to realize intuitive user remarks represented in standardized formats. Standardized remarks provided by users and standardized meta data formats are used by the client-side control logic and the analyses component for semantic interpretations of the document content. The standardized meta data formats and predefined categories of remarks are resulting in a better structuring of the user remarks. Said structuring also allows the server for additional information or the client-side control logic to filter out, modify, present at a more prominent place, or otherwise influence the presentation of remarks made by other users.

In any specific embodiment the client-side control logic can, in addition, request identification information from the user. Based on the identification information the server for additional information can provide private or group based additional information in such a manner, that the additional information will be accessible only to the user or to members of a group the user is able to define.

In another specific embodiment, the server for additional information stores user specific social profiles containing the user's preferences for social contacts. In addition the server for additional information tracks and stores the user specific surf behavior (for example: URLs, sequence of URLs visited, time between visited pages, scrolling behavior on the page, dynamics of mouse movement, fact whether the user uses help pages). Based on the social profiles and the surf behaviors a matching score of users is calculated. If this score is higher than a certain threshold this users will be provided with the options of connecting with the matched set of users in such a manner, that the client-side control logic provides additional information in the additional output component which enable the user to directly communicate synchronously (for example: VoIP, chat, ICQ, messenger, video conferencing) or asynchronously (for example: email, blog, forum, wiki, guest book, voice mail, sms, fax) with the set of matched users.

In another specific embodiment, the additional information provided to the user consists of recommendations of documents in which the user might be interested. For this purpose, the client-side control logic provides the server for additional information with information on which web pages an individual user look at. This information can be augmented with web page usage information, such as the time spent in reading a specific web page, the links on that page the user did click on, the keywords embedded in that web page, etc. The server for additional information then can use statistical strategies for making suggestions at which web pages the users should also look at (for example by placing a list of these suggested links onto the additional output component or by providing special graphical markup on the link test such as a special background color, text color or a smiling face or another graphical symbol placed directly to said links in the main output component) and which web links might be less interesting for the user (for example by using methods similar as the one outlined above). The server for additional information can base these suggestions on several strategies. In one possible strategy, the server uses the technique for deriving a topic from the viewed web page by using clustering document-similarity fingerprints. If the server comes to the conclusion that the user is interested in a certain topic, it can then suggest that the user takes a look at the best rated web pages on this topic. In another possible strategy, the server employs association rule analysis (users who look at link X also had a look at link Y with probability P) or another established form of recommendation technique.

In another specific embodiment, the additional information provided to the user consists in recommendations of documents in which the user might be interested. For this purpose, the analysis component provides the client-side control logic with information about the content of the web page a user is viewing. This information can include document fingerprints, pattern, speech and audio data, full text information, indices, and other analysis information. The client-side control logic compares the analysis information of the current document with in former times stored analysis information of other documents to recognize similar documents and/or document sources for making suggestions on which web pages the users should also look at (for example by placing a list of these suggested links onto the additional output component or by providing special graphical markup on the link test such as a special background color, text color, or a smiling face, or another graphical symbol placed directly to said link in the main output component) and which web links might be less interesting for the user (for example by using methods similar as the one outlined above). The client-side control logic can base these suggestions on several strategies, depending on the selected control module.

In another specific embodiment, the information extracted by the document analysis component consists of information on products which are bought by the user or the details of products which are downloaded from an electronic commerce web site. As a result, the server for additional information is informed on all shopping related activities of the user and thus can deduce a consumer and buyer profile which is more reliable than in a situation where only the shopping activity at a single site is known. The server for additional information then can provide the user with specially targeted information such as product recommendations, product alternatives, accessories for owned products and other suggestions.

In another specific embodiment, the interceptor catches the URL from a user requested document and forwards it to the client-side control logic. The client-side control logic connects the server for additional information to retrieve information associated with that URL and/or its internet-domain name and generates additional information in such a manner that the information bound to the specific URL and/or internet-domain name of the requested document will be displayed in the additional output component. The generated additional information can be presented itself, as hyperlinks, or a combination thereof.

In another specific embodiment, the interceptor catches the URL from a user requested document and forwards it to the client-side control logic. The client-side control logic connects the server for additional information to retrieve information associated with that URL and/or its internet-domain name and replaces the URL in the interceptor in such a manner that the information bound to the specific URL and/or internet-domain name of the requested document will be used to derive a new-URL which is then send back to the interceptor. In consequence the information stored at the new-URL will be displayed in the browser.

In another specific embodiment, the interceptor catches the URL from a user requested document and forwards it to the client-side control logic. The client-side control logic connects the server for additional information to retrieve information associated with that URL and redirects the browser base on the additional information in such a manner, that it sends a document change request to the document representation interface which than simply sends a redirect message to the browser.

In another specific embodiment, the interceptor catches the URL from a user requested document and forwards it to the client-side control logic and/or the analysis component. The client-side control logic connects to the server for additional information to retrieve information associated with that URL and/or its internet-domain name. If the requested document or URL contains material which shall not be accessible by certain users, e.g. children, the client-side control logic receives a warning from the server for additional information or from the analysis component. By virtue of the warning the client-side control logic replaces the URL in the interceptor in such a manner that the information bound to the specific URL and/or internet-domain name of the requested document will be used to derive a new-URL which is then send back to the interceptor or the client-side control logic modifies the presented document in the document representation interface. In dependency of additional control modules further change and enrichment processes can be performed. In another case the client-side control logic blocks or modifies only a part of the requested document and leaves the remainder as is. The described procedure of the client-side control logic can also be activated by analysis information from the analysis component without having recourse to the server for additional information and can also be used to block any defined content.

In another specific embodiment, the apparatus is utilized for educational purposes to provide professional training or academic instruction. For example, the content of browser of one client can be presented simultaneously in a number of browsers of other clients. In this case, a client and its cooperative system component, configured as master, is connected to other clients and their cooperative system components, configured as slave, via a network. The configuration of the behavior of the cooperative system components is assured by the subscription of the corresponding control module and the dependant behavior of the client-side control logic. Each interceptor of the slaves catches the documents from the output components of the instructor to represent the content in their own output component. This embodiment can also be used in other cases, e.g. internet-radio where the master client plays the role of the radio transmitter and broadcasts a stream of audio data. The interceptor of the slave clients catches the stream, the slave client-side control logic processes these data and represents the audio content via the slave's additional output component, e.g. soundcards and speaker. The configuration as master or slave must not be persistent, as necessary, all clients can assume any of the two roles. In the case of assuming both roles (master and slave) at the same time, the clients are of equal rights and it is possible to establish an interactive synchronized communication between the clients, e.g. usable for chats, meetings, whiteboards, computer supported cooperative work scenarios (CSCW) or multiplayer games.

Based on information provided by the control modules, interceptor, and analysis component, in another specific embodiment, the client-side control logic requests a quantity of n documents, including all their embedded elements, from the network and stores the documents in the client-side control logic data cache for further processing or forwarding to the output components. The output component or the additional output component then generates n output objects to present one of the documents in each by immediately parsing the documents and performing their flow of the layout. This output objects are hidden and will only be made visible by the output component or the additional output component in such a manner that, depending on the user's further input, only one or none of this objects will be made visible at the time by the output component or the additional output component.

### BRIEF DESCRIPTION OF THE DRAWINGS

For a better understanding of the invention embodiments of it will now be described, by way of example, with reference to the accompanying drawings, in which:

FIG. 1 is a flowchart of steps of a method for generating output content with utilization of user input in accordance with an exemplary embodiment of the present invention;

FIG. 2 is a block diagram depicting a network architecture that facilitates the analysis of user requested documents and the generation and search of additional information in dependency to specific control modules in accordance with an exemplary embodiment of the present invention;

FIG. 3 is a block diagram depicting the functions within a user client in accordance with an exemplary embodiment of the present invention;

FIG. 4 is a block diagram depicting the generation of additional information in reference to a user requested document in accordance with an exemplary embodiment of the present invention;

FIG. 5 depicts the possibilities of analysis of a user requested document in accordance with an exemplary embodiment of the present invention;

FIG. 6 depicts the possibilities of loading and generation additional information and documents in accordance with an exemplary embodiment of the present invention;

FIG. 7 is a block diagram depicting the communication of clients in accordance with an exemplary embodiment of the present invention;

FIG. 8 depicts the cooperation of the entirety of described components in an architecture in accordance with an exemplary embodiment of the present invention.

### DETAILED DESCRIPTION

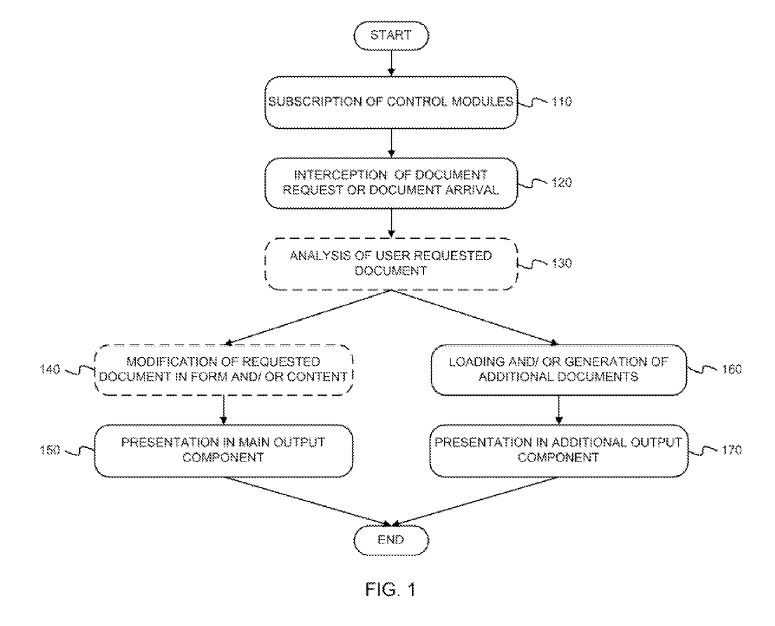

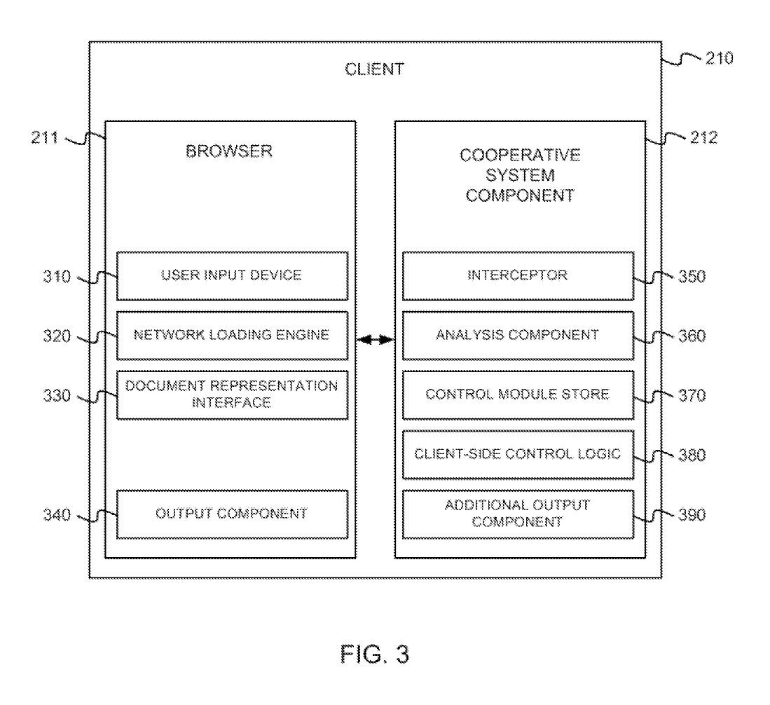

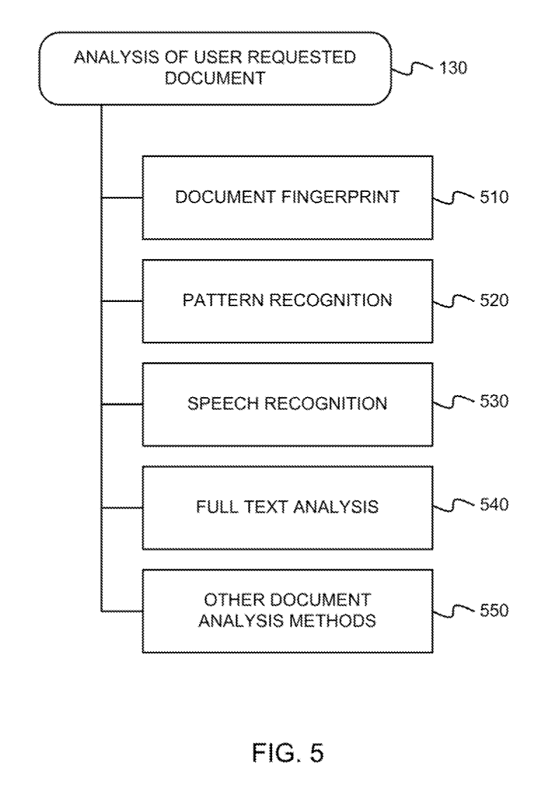

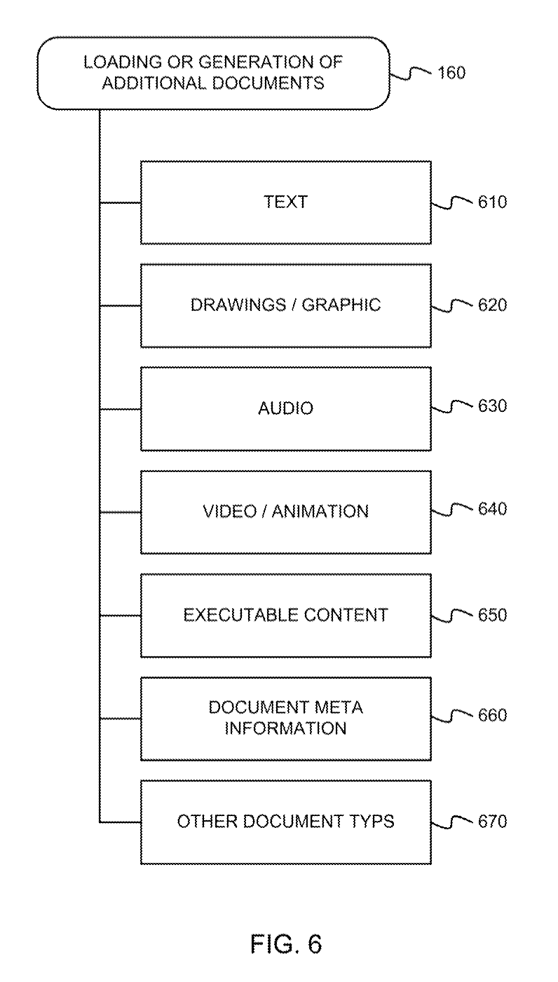

With reference to FIG. 1 and FIG. 3, a method for generating output content with utilization of user input includes a method for subscription of control modules 110, a method for interception of document request and/or document arrival 120, a method for analysis of user requested documents 130, a method for modification of requested documents in form and/or content 140, a method for loading and generation of additional documents 160, a method for presenting the user requested document in a main output component 150 and a method for presenting additional documents in an additional output component 170. The subscription of control modules 110 defines the exact manner of executing the methods 120, 130, 140, 150, 160 and 170. The user has the choice to select and subscribe to different control modules 110 from a control module store 370 via a user input device 310 or to use default control modules without an explicit subscription. The interceptor 350 catches the document requested by a user via a browser 211. This interception returns the document location, such as a uniform resource locator (URL), of the document. Depending on the selected control module the client-side control logic 380 may replace the URL in the interceptor 350 with a new-URL. In another case the interceptor 350 catches the received document requested by the user. In dependency of the selected control module the client-side control logic 380 initiates the analysis of the user requested document 130. Possible variations of analysis-methods are shown in FIG. 5. The analysis-method 130 is optional and can be deactivated in specific control modules. With the results of 130 or the guidelines of the subscribed control modules 110 the selective modification of the user requested document 140 can be accomplished and visualized via the main output component 150. Modifications of the requested document 140 include highlighting, coloring or any similar change in the graphical representation, replacement, insertion, and deletion of any content, for example insertion of text-based notes or audio as well as the connection of one kind of content with another kind (e.g. text can be added to audio content and vice versa). In specific control modules the modification component 140 is deactivated and an unchanged requested document will be visualized in 150. In another specific control modules the result of 130 leads to a blockade of the user requested document and no document will be displayed in the main output component 150. In dependency of the results of analysis of the user requested document 130 or the guidelines of the subscribed control modules 110 the client-side control logic 380 loads or generates additional documents 160. In the case of interception of the URL 120 its information will be used to load and/or generate additional documents 160. Possible variations of usable documents for loading and generation 160 are shown in FIG. 6. The resulting documents of 160 will be presented 170 via additional output components 390. For example audio documents can be presented via the user's audio peripherals, text and image documents via the user's browser, and video documents as a combination thereof.

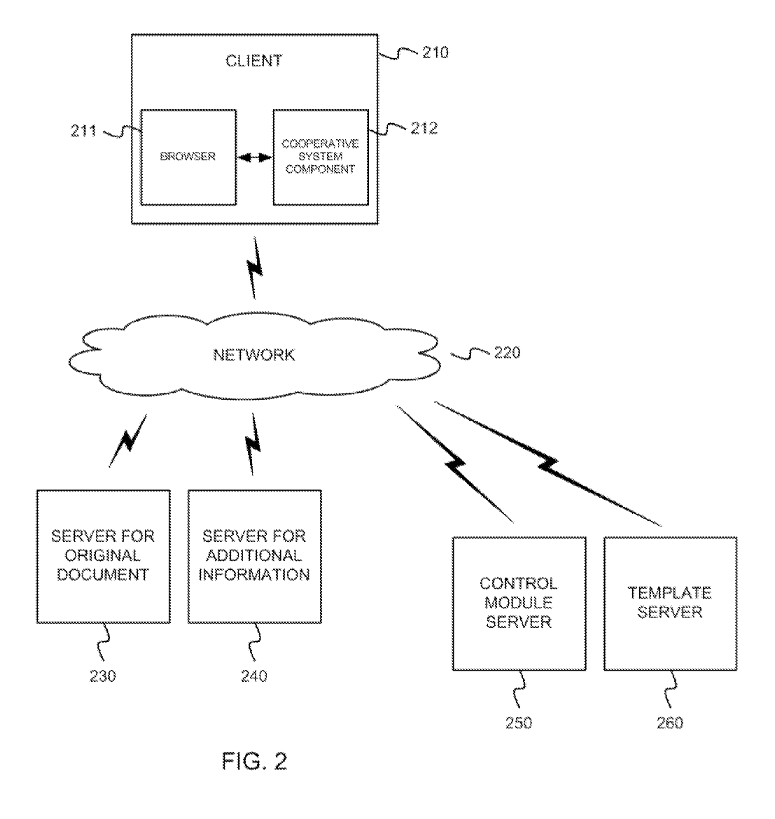

FIG. 2 is a block diagram depicting a network architecture that facilitates the analysis of user requested documents and generating and searching of additional information in dependency to specific control modules in accordance with an exemplary embodiment of the present invention. A client 210 using a browser 211 and a cooperative system component 212 is connected via a Network 220 with a server for original documents 230, a server for additional information 240, and is optionally connected with a control module server 250 and a template server 260. The connections via network 220 may include telephone lines, DSL, cable networks, T1 lines, ATM/SONNET, wireless networks, or any other arrangement that allows for the transmission and reception of network signals. Servers for original documents 230 are without loss of generality web servers with HTML documents, suppliers of user requested documents, and additional information for the server for additional information 240. In dependency of specific control modules the cooperative system component 212 loads additional information from the server 240. In cooperation with information from the template server 260 the cooperative system component 212 generates documents for client-side use. The template server 260 is an optional component in the network architecture and not implicitly essential for the tasks of the cooperative system component 212. The control module server 250 provides the cooperative system component 212 with additional control modules which can be loaded by the client if needed. The server for additional information 240 delivers additional information to the cooperative system component 212 of the client 210 and has the capability to load supplementary required information from the servers for original documents 230.

FIG. 3 is a block diagram depicting the functions within a user client in accordance with an exemplary embodiment of the present invention. Used Components of a browser 211 are a user input device 310, a network loading engine 320, a document representation interface 330, and an output component 340. Components of the cooperative system component are an interceptor 350, an analysis component 360, a control module store 370, a client-side control logic 380, and an additional output component 390. A user uses the user input device 310 to request a specific document and to communicate with the cooperative system component 212, especially to subscribe control modules from the control module store 370. The selection of control modules can be accomplished any time the user uses the invention and will be stored and used until the user change the subscription. If no user subscription of control modules is made the cooperative system component 212 automatically subscribes to a set of default control modules. With reference to FIG. 3 and FIG. 2 the network loading engine 320 loads the requested document over the network 220 from the server for original document 230. The document representation interface 330 provides the loaded document for the analysis in the analysis component 360 and enables the representation of the modified original document, which is modified by the client-side control logic 380. The client-side control logic 380 loads and generates additional information and formats it to a document which is presented in the additional output component 390. In addition, and in dependency of the selected control module, the client-side control logic 380 reformats the requested original document to endue this document with references to the generated additional information presented in the additional output component 390. The reformatted requested document is presented in the output component 340. In an alternative case the output channels are interchanged such that the modified original document is presented in the additional output component 390 and the additional information document is presented in the output component 340.

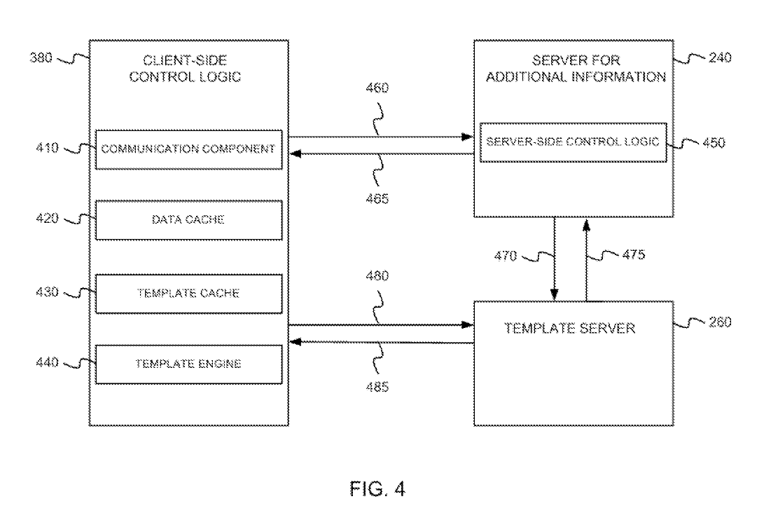

FIG. 4 is a block diagram depicting the generation of additional information in reference to a user requested document in accordance with an exemplary embodiment of the present invention. Components of the client-side control logic 380 are a communication component 410, a data cache 420, a template cache 430, and a template engine 440. A server-side control logic 450 is a component of the server for additional information 240. With reference to FIG. 4 and FIG. 3 the client-side control logic 380 receives analysis results from the analysis component 360 and information about the selected control modules from the control module store 370. Depending on these information the client-side control logic 380 connects 460 the server-side control logic 450 via the communication component 410. The server-side control logic 450 holds fitting information and their application in special control modules. In addition the server for additional information 240 is connected 470 to the template server 260 and gets information 475 about templates available on the template server 260. These information will be transferred 465 to the communication component 410. The client-side control logic 380 decides on requesting 460 and loading 465 of required information from the server for additional information 240, on requesting 480 and loading 485 of templates from the template server 260, on the use of available information held in the data cache 420, and on the use of available templates in the template cache 430. In dependency of the selected control module the available information will be used in the template engine 440 to create additional documents presented in the additional output component 390 for representation in the document representation interface 330 and visualization in the output component 340.

FIG. 5 depicts the possibilities of analysis of a user requested document in accordance with an exemplary embodiment of the present invention. A document fingerprint 510 is computation of a mathematical value in dependency of the characteristics of a specific document which can be used to compare different documents. Pattern recognition 520 is an automatic identification and evaluation of pattern in signals for comparison of different sources such as pictures. The methods for pattern recognition 520 may include syntactic and statistic procedures. Speech recognition 530 is used to analyze human speech to compare different audio sources or to transfer the audio information in written text. Full text analysis 540 analyses the entirety of all words of a document. The analysis of user requested document 130 can also be executed with other document analysis methods 550 or combinations of methods listed in FIG. 5.

FIG. 6 depicts the possibilities of loading and generating additional information and documents in accordance with an exemplary embodiment of the present invention. Text 610 may include arbitrary written languages presented in arbitrary formats and standards such as Unicode. Drawings/graphic documents 620 may include lossy and lossless graphic formats, vector graphic formats, like CGM, DXF, SVG, VRML, and raster graphic formats, like GIF, JPEG, PSD, TGA, TIFF. Audio documents 630 may include lossy and lossless formats like AIFF, WAV, MP2, MP3, WMA, VORBIS. Video/Animation 640 may include lossy and lossless formats, like Animated GIF, ASF, AVI, Makromedia Flash, MPEG, Quicktime, Realmedia. Documents with executable content 650 may include source code and object code, such as exe-files or scripts. Document meta information 660 contains information about documents such as electronic signatures, versioning history, authentication, dublin core. It is possible to load or generate diverse other document types 670, for example geographic information system (GIS) formats like Coverage, Shape, MIF or SQD files.

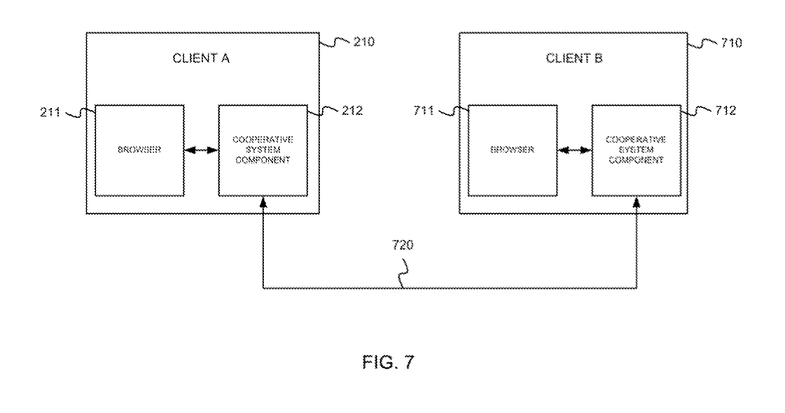

FIG. 7 is a block diagram depicting the communication of clients in accordance with an exemplary embodiment of the present invention. With reference to FIG. 7 and FIG. 2 a client 210 and a cooperative system component 212 is connected to a client 710 and a cooperative system component 712 via a network 220. With use of the connection 720 both clients 210 and 710 exchange information to realize, e.g., a computer supported cooperative work system. In the present invention an arbitrary number of clients 210, 710 can comprise such an apparatus.

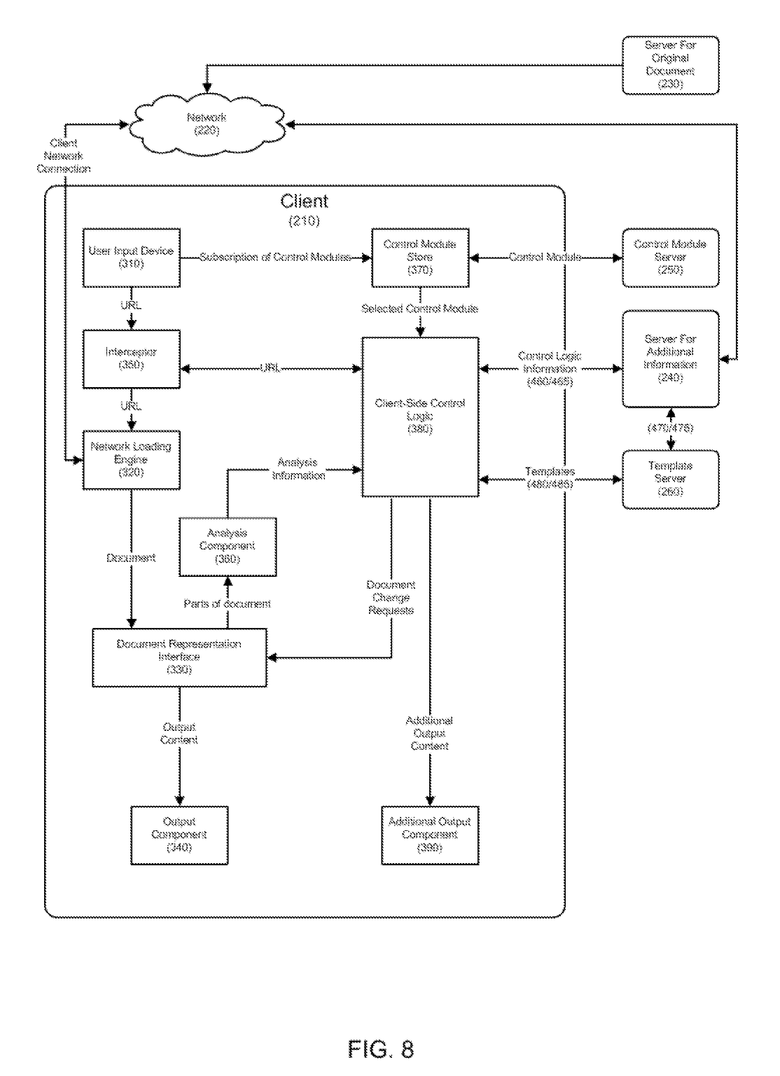

FIG. 8 depicts the cooperation of the entirety of described components in an architecture in accordance with an exemplary embodiment of the present invention. In this specific realization of use of the components described in FIG. 2, FIG. 3, FIG. 4, and FIG. 7 the interceptor 350 catches the requested document locator, e.g. a URL, of a document located at a server for original document 230 directly from the user input device 310 and forwards it to the client-side control logic 380 and the network loading engine 320. The whole loaded document or parts of it presented in the document representation interface 330 will be analyzed in the analysis component 360 and analysis information will be delivered to the client-side control logic 380. With information about subscribed or default control modules from the control module store 370 the client-side control logic connects the server for additional information 240 to get information about usable templates from template server 260 and further information for example additional data or instructions. In dependency of selected control modules the client-side control logic 380 uses these information to modify the original document to a changed presentation in the document representation interface 330 and visualization in the output component 340 and to create additional output content for presentation in the additional output component 390.

What is claimed is:

1. An apparatus for organizing, analyzing, processing, generating, interpreting, intercepting, presenting, registering, enriching, and exchanging information or a collection of documents, comprising: (A) a client: having a browser; and a cooperative system component, which communicates with the browser; (B) a network; (C) a server for original document to supply the user requested documents and to supply additional information; (D) a server for additional information to store additional information, to deliver additional information to the cooperative system component, and to load supplementary required information; (E) an optional control module server to provide the cooperative system component with additional control modules; and (F) an optional template server to supply templates.

2. The apparatus of claim 1, wherein said client, said server for original document, said server for additional information, said control module server and said template server communicate over said network.

3. The apparatus of claim 1, wherein said cooperative system component comprises: an interceptor to catch the document locator of the user requested document; an analysis component to analyze the user requested document; a control module store to provide control modules for subscription through a user and to control the execution of the client-side control logic via the control modules; a client-side control logic to modify the user requested document and to request, to load, to generate, and to format additional information; and an additional output component to present the modified document and to present the additional information.

4. The apparatus of claim 3, wherein said client-side control logic comprises: a communication component to communicate with said server for additional information of claim 1; a data cache to temporarily store information; a template cache to temporarily store templates; and a template engine to create additional documents.

5. The apparatus of claim 1, wherein said server for additional information comprises a server-side control logic to manage fitting information and their application.

6. The apparatus of claim 1, wherein said browser is part of a web browser; or part of an operating system; or part of an extendable application; or any combination thereof.

7. The apparatus of claim 1, wherein said browser comprises: (A) a user input device to provide the communication between user and cooperative system component; and to provide user requests of documents; (B) a network loading engine to load the requested document over the network of claim 2; (C) a document representation interface to provide the loaded document for the analysis in the analysis component of claim 3; (D) and an output component to present the reformatted requested document.

8. The apparatus of claim 3, wherein said analysis component analyses a user requested document to extract the topic of that document and to send this topic to the server for additional information to enable the server-side control logic of claim 5: to find similar topics; or to store a remark to a specific topic.

9. The apparatus of claim 3, wherein said client-side control logic provides user support elements comprising: standardized masks; or drag-and-drop elements; or standardized interaction options; or predefined categories of remarks to prevent incorrect user input; or enable better structuring of user remarks and to enable semantic interpretations of document content through said analysis component and said client-side control logic.

10. The apparatus of claim 3, wherein said client-side control logic requests identification information from the user to classify the user to a specific user group.

11. The apparatus of claim 10, wherein said specific user group provides specific access rights to access specific additional information on the server for additional information of claim 1.

12. The apparatus of claim 1, wherein said server for additional information stores user specific social profiles containing the user's preferences for social contacts.

13. The apparatus of claim 1, wherein said server for additional information stores user specific surf profiles, generated by tracking the user specific surf behavior comprising: visited URLs; or sequences of visited URLs; or time between visited pages; or scrolling behavior on a page; or dynamics of mouse movements; or other user behavior; and any combination thereof.

14. The apparatus of claim 5, wherein said server-side control logic calculates user scores using the user specific social profiles of claim 12 and the user specific surf profiles of claim 13 to identify users with scores higher than a certain threshold.

15. The apparatus of claim 1, wherein said server for additional information provides said cooperative system component with the matched set of said identified users of claim 14 displayed in said additional output component of claim 3 enriched with possibilities for synchronously communication and possibilities for asynchronously communication with said matched set of said identified users of claim 14.

16. The apparatus of claim 15, wherein said possibilities for direct synchronously communication comprising: Voice over IP; or chat; ICQ; AIM; or messenger; or video conferencing; or other synchronously communication ways; and wherein said asynchronously communication comprising: email; or blog; or forum; or wiki; or guest book; or voice mail; or sms; or fax and other asynchronously communication ways.

17. The apparatus of claim 1, wherein said server for additional information is provided by said client-side control logic of claim 3 with analysis information on which document a user looks at, for recommendation of other documents in which the user might be interested.

18. The apparatus of claim 17, wherein said analysis information consist of: a document identifier; or web page usage information; or a combination thereof.

19. The apparatus of claim 18, wherein said web page usage information comprises: the time spent in reading a specific web page; or the links on that page the user clicks on; or keywords embedded in that web page; or other web page usage information; or any combination thereof.

20. The apparatus of claim 17, wherein said server for additional information uses strategies to calculate said recommendation of other documents and send said recommendation to said cooperative system component of claim 1 for presentation in said additional output component of claim 3 and/or in said output component of claim 7.

21. The apparatus of claim 17, wherein said recommendation of other documents is indicated by: a list of hyperlinks; or background color; or text color; or other special graphical markup; or icons; or other indicators; or any combination thereof.

22. The apparatus of claim 20, wherein said strategies to calculate said recommendation of other documents consists of: using the user specific surf profiles of claim 13; using the technique for deriving a topic from the viewed web page by using clustering document-similarity fingerprints and finding the topic the user is interested in; employment of association rule analysis; or other established forms of recommendation techniques.

23. The apparatus of claim 3, wherein said client-side control logic is provided by said analysis component with analysis information about the content of the document a user looks at, for recommendation of other documents in which the user might be interested.

24. The apparatus of claim 23, wherein said analysis information consists of: document fingerprints; or pattern; or speech; or audio data; or full text information; or indices; other analysis information; or any combination thereof.

25. The apparatus of claim 23, wherein said client-side control logic compares the analysis information of the current document with historical stored analysis information of other documents to recognize: similar documents; and document sources for calculation of said recommendation of other documents on which the users should look at.

26. The apparatus of claim 25, wherein said recommendation of other documents is presented in said additional output component of claim 3 and/or in said output component of claim 7.

27. The apparatus of claim 25, wherein said recommendation of other documents is indicated by: a list of hyperlinks; background color; text color; other special graphical markup; icons; other indicators; or any combination thereof.

28. The apparatus of claim 1, wherein said server for additional information is provided by said cooperative system component with: information on products which are bought by the user; or information on product purchases; or product details which are downloaded from an electronic commerce web site; or any combination thereof, for recommendations of: products; product alternatives; accessories for owned products; or any other specially targeted information.

29. The apparatus of claim 28, wherein said information on bought products, information on product purchases and downloaded product details is stored in said server for additional information and used to generate a consumer and buyer profile.

30. The apparatus of claim 1, wherein said client is connected via the cooperative system component and a network to one or more cooperative system components of other clients of claim 1 to utilize the apparatus for mutual communication.

31. The apparatus of claim 30, wherein said mutual communication is configured by the subscribed control module from the control module store of claim 3 used for: educational purposes to provide professional training or academic instructions; internetradio; interactive synchronized communication comprising: chats, meetings, whiteboards, computer supported cooperative work scenarios (CSCW) or multiplayer games; or other communication scenarios.

32. The apparatus of claim 1, wherein said cooperative system component requests a quantity of additional documents, including all their embedded elements, over said network and stores the documents in the client-side control logic data cache of claim 4 for further processing.

33. The apparatus of claim 32, wherein said request of additional documents is based on analysis information of the analysis component of claim 3 and/or the information of the interceptor of claim 3.

34. The apparatus of claim 32, wherein said further processing comprises following steps: forwarding of additional documents to the output component of claim 7 and/or the additional output component of claim 3; generation of output objects to present one of the documents in each output component by immediately parsing the documents and performing their flow of the layout but without displaying the results; making visible one or none of the output objects in the output component or the additional output component, depending on the user's further input.

35. A method for generating output content with utilization of user input comprising the methods of: a method for subscription of control modules; a method for interception of document request or document arrival; a optional method for analysis of user requested document; an optional method for modification of requested document in form and/or content; a method for presentation in main output component; a method for loading and/or generation of additional documents; and a method for presentation in additional output component.

36. The method of claim 35, wherein said subscription of control modules with said method for subscription of control modules defines the exact manner of executing: said method for interception of document request or document arrival; said method for analysis of user requested document; said method for modification of requested document in form and/or content; said method for presentation in main output component; said method for loading and/or generation of additional documents; and said method for presentation in additional output component.

37. The method of claim 35, wherein said output content is a text; a hyperlink; a drawing; a graphic; an audio content; a video; an animation; an executable content; a document meta information; other document types; or any combination of said contents.

38. The method of claim 35, wherein said analysis of user requested document can be realized with: analysis of document fingerprint; pattern recognition; speech recognition; full text analysis; other document analysis methods; or any combination thereof.

39. The method of claim 35, wherein said method for analysis of user requested document recognizes: (A) product identification information within the user requested document by searching the document at those places where electronic commerce shopping sites usually display product identification information; or (B) special identification information within the user requested document.

40. The method of claim 39, wherein said special identification information is at least one of: an International Standard Serial Number (ISSN); or an International Standard Book Number (ISBN); or a Document Object Identifier (DOI); or a Label Code (LC); or an International Standard Recording Code (ISRC); or a universal product code (UPC); or a European article numbering (EAN) code; or any standardized information with: a mathematical basis of computation like ISBNs and checksum rules; globally allocated numbers like LCs; unique identifiers; or other allocated identification characteristics.

41. The method of claim 35, wherein said method for loading and/or generation of additional documents utilizes the analysis results of the method of claim 39 to generate a document with: offers; or product information; or other commercial content.

42. The method of claim 41, wherein said offer is: a hyperlink to a commercial offerer; a method for a direct purchase; or any combination thereof.

43. The method of claim 35, wherein said method for analysis of user requested document recognizes arbitrary objects within the user requested document and said method for modification of requested document in form and/or content modifies these arbitrary objects within the user requested document.

44. The method of claim 43, wherein said arbitrary object is: a word; or a text; or a document location; or a user requested document itself; or the topic of a user requested document; or a drawing; or a graphic; or a audio files; or a video file, or an animation; or an executable content; or a document meta information; or other document types.

45. The method of claim 43, wherein said modification of objects within the user requested document is accomplished by: adding information through the user; or by loading object information of other users; or any combination thereof.

46. The method of claim 45, wherein said loaded object information of other users comprises: remarks to documents which are stored under different document locations but have identical or similar contents; or identical or similar topics as the user requested document.

47. The method of claim 35, wherein said method for analysis of user requested document recognizes a specific URL.

48. The method of claim 35, wherein said method for modification of requested document in form and/or content replaces the specific URL of claim 47 with a substitute URL based on the analysis information of the method of claim 47.

49. The method of claim 35, wherein said method for presentation in main output component presents the substitute URL of claim 48.

50. The method of claim 35, wherein said method for modification of requested document in form and/or content replaces the specific URL with a substitute message based on the analysis information of the method of claim 47.

51. The method of claim 35, wherein said method for presentation in main output component presents the substitute message of claim 50.

52. The method of claim 35, wherein said method for subscription of control modules is used to define restrainable content comprising: PG-rated content; PG-13-rated content; R-rated content; NC-17-rated content; or any content which shall be restricted for a specific person or a group of people and wherein said method for analysis of user requested document recognizes this restrainable content within the user requested document.

53. The method of claim 35, wherein said method for modification of requested document in form and/or content replaces the URL of the user requested document with a new URL based on the subscribed control module of the method of claim 52 and based on the analysis information of the method of claim 52.

54. The method of claim 35, wherein said method for modification of requested document in form and/or content executes modifications of the user requested document based on the subscribed control module of the method of claim 52 and based on the analysis information of the method of claim 52.

55. The method of claim 54, wherein said modifications of the user requested document comprising: a modification of the entire document; or a modification of parts of the document; or a blocking of parts of the document; or any combination thereof.

56. The method of claim 35, wherein said method for loading and/or generation of additional documents generates a document containing registered alternative URLs, optionally with alternative TLDs, presented in any form of representation of hyperlinks, based on the recognition information of said method for analysis of user requested document of claim 47.

57. The method of claim 35, wherein said method for presentation in additional output component presents the document of claim 56.
